(19) United States
(12) Patent Application Publication
(10) Pub. No.: US 2025/0223679 A1
(43) Pub. Date: Jul. 10, 2025

(54) NANOCRYSTALLINE ALLOY RIBBON AND MAGNETIC SHEET

(71) Applicant: Proterial, Ltd., Tokyo (JP)

(72) Inventors: Yuichi OGAWA, Tokyo (JP); Kotoba TOYONAGA, Tokyo (JP)

(21) Appl. No.: 18/852,684

(22) PCT Filed: Mar. 30, 2023
(86) PCT No.: PCT/JP2023/013211

§ 371 Date: Sep. 30, 2024

(30) Foreign Application Priority Data
Mar. 30, 2022 (JP) 2022-055679

(51) Int. Cl. C22C 45/02; C21D 9/46

(52) U.S. Cl. CPC C22C 45/02; C21D 9/46; C22C 2200/04; C22C 2202/02

(57) ABSTRACT

A nanocrystalline alloy ribbon is provided which has excellent magnetic properties including high saturation magnetic flux density and high magnetic permeability. The nanocrystalline alloy ribbon is represented by composition formula: (Fe₁₋ₓAₓ)ₐSi_{b}B_{c}Cu_{d}Mₑ, where A is at least one type of Ni and Co, M is at least one type of element selected from a group consisting of Nb, Mo, V, Zr, Hf and W, and in at %, 75.0≤a≤81.0, 9.0≤b≤17.5, 5.0≤c≤10.0, 0.02≤d≤1.5, 0.1≤e≤3.5 and 0≤x≤0.1 are satisfied, an αFe crystal phase having an average crystal grain size of 50 nm or less accounts for 40% or more by volume fraction, a saturation magnetic flux density is 1.36 T or more, a ratio Br/B₈₀₀₀ of a residual magnetic flux density Br to a magnetic flux density B₈₀₀₀ at a magnetic field of 8000 A/m is 0.20 or more, and a maximum magnetic permeability is 4000 or more.

### CROSS-REFERENCE TO RELATED APPLICATION

This international application claims the benefit of Japanese Patent Application No. 2022-055679 filed on Mar. 30, 2022 in the Japan Patent Office, and the entire disclosure of Japanese Patent Application No. 2022-055679 is incorporated herein by reference.

### TECHNICAL FIELD

The present disclosure relates to a nanocrystalline alloy ribbon having a nanocrystalline structure, and a magnetic sheet using the same.

### BACKGROUND ART

Low magnetostrictive nanocrystalline alloy ribbons having a nanocrystalline structure have been known. The nanocrystalline alloy ribbons have excellent magnetic properties of high magnetic permeability and low loss, and exhibit these excellent magnetic properties over a wide frequency band. The nanocrystalline alloy ribbons are used in magnetic components such as transformers, motors, choke coils, magnetic shields, and current sensors.

With the increasing frequency of semiconductors, many of these magnetic components have specifications of higher operating frequency. As a result, soft magnetic materials used are increasingly being switched to nanocrystalline alloy ribbons. In order to achieve further miniaturization of components, there is a need to further increase the saturation magnetic flux density of the low magnetostrictive nanocrystalline alloy ribbons, which is approximately 1.2 T.

In recent years, contactless charging has been adopted or is being considered for adoption as a charging method for mobile phones, small electrical appliances, electronic devices, electric vehicles, and the like. In a contactless charging device, a nanocrystalline alloy ribbon is sometimes used as a magnetic core of a transmitter/receiver coil or a soft magnetic material for magnetic shielding. Main properties required for soft magnetic material for contactless charging are high magnetic permeability, low loss, high saturation magnetic flux density, and thinness.

Currently, the frequency band mainly used for power transfer in contactless charging is around 100 kHz. The soft magnetic material mainly used is limited to ferrite and nanocrystalline alloy ribbons. The nanocrystalline alloy ribbon is very thin, having a thickness of approximately 20 μm or less, and has a saturation magnetic flux density approximately three times that of ferrite. Thus, the nanocrystalline alloy ribbon is excellent in miniaturization and thinning, and greatly contributes to making a transmitter/receiver coil set small and thin. For these reasons, nanocrystalline alloy ribbons are being adopted or considered for adoption in contactless charging coils in a variety of products.

In contactless charging, there is a tendency for the charging output to be increased in order to shorten the charging time. In this case, it is effective to increase an amount of magnetic flux flowing through the soft magnetic body. Possible methods for compensating for the increase in the amount of magnetic flux include increasing the amount of nanocrystalline alloy ribbon used, or switching to a nanocrystalline alloy ribbon with higher saturation magnetic flux density without changing the amount used, and the latter is particularly desired. In addition, in contactless charging, magnetic flux flows from the coil in a thickness direction of the alloy ribbon, and then flows from the center to the outside in the plane. Thus, it is preferable that the nanocrystalline alloy ribbon has isotropic magnetic properties.

Japanese Unexamined Patent Application Publication No. 2008-196006 discloses a Fe-based nanocrystalline soft magnetic alloy having a composition represented by general formula: Fe_{100-x-a-y-z}A_{z}MₐSi_{y}B_{z} (at %), where A represents at least one type of element selected from Cu and Au, M represents at least one type of element selected from Ti, V, Zr, Nb, Mo, Hf, Ta, and W, and x, a, y and z respectively satisfies 0≤x≤2, 0≤a≤1.5, 13≤y≤18, 4≤z≤10, and x+a+y+z≤25, and is composed of bcc Fe—Si crystal grains with an average grain diameter of 120 nm or less and an amorphous phase, and in which the bcc Fc-Si crystal grains accounts for 50% or more of the structure by volume fraction; a saturation magnetic flux density Bs satisfies 1.4 T or more, and a saturation magnetostriction constant λs lies in a range of −3.5×10⁻⁶ or more and 3.5×10⁻⁶ or less.

Japanese Unexamined Patent Application Publication No. 2014-516386 discloses an alloy consisting of Fe_{100-a-b-c-d-x-y-z}Cu_{z}Nb_{b}M_{c}T_{d}Si_{y}B_{z}Z_{z} and impurities up to 1 at %, where M is one or more types of elements Mo, Ta and Zr, T is one or more types of elements V, Mn, Cr, Co and Ni, Z is one or more types of elements C, P and Ge, and 0 at %≤a<1.5 at %, 0 at %≤b<2 at %, 0 at %≤(b+c)<2 at %, 0 at %≤d<5 at %, 10 at %<x<18 at %, 5 at %<y<11 at % and 0 at %≤z<2 at %. The alloy is in the shape of a ribbon and has a nanocrystalline structure in which at least 50 vol % of the grains have an average size of less than 100 nm, a hysteresis loop with a central linear part, a remanence ratio Jr/Js<0.1, and coercive force He to anisotropic field intensity Ha ratio<10%.

### PRIOR ART DOCUMENTS

### Patent Documents

Patent Document 1: Japanese Unexamined Patent Application Publication No. 2008-196006
Patent Document 2: Japanese Unexamined Patent Application Publication No. 2014-516386

### SUMMARY OF THE INVENTION

### Problems to be Solved by the Invention

The saturation magnetic flux density of the nanocrystalline alloy ribbon depends on the amount of Fe contained. Further, in order for the nanocrystalline alloy ribbon to have excellent magnetic properties, it is necessary to have a fine nanocrystalline structure with an average grain diameter of 50 nm or less. For this purpose, it is essential to add Cu which promotes nucleation and Nb which inhibits grain growth of crystal grains. In addition, in order for the nanocrystalline alloy ribbon to maintain low magnetostriction, it is necessary to add a certain amount of Si. Although it depends on values of desired magnetic properties, a saturation magnetic flux density of approximately 1.20 T to 1.35 T can be achieved by maintaining the fine nanocrystalline structure with an average grain diameter of 50 nm or less, and adjusting the amounts of Cu, Nb, and Si so that the magnetostriction is 7 ppm or less.

Patent Document 1 discloses a low magnetostrictive nanocrystalline alloy ribbon having a saturation magnetic flux density of 1.4 T or more. However, in order to increase the saturation magnetic flux density, the amounts of Cu and Nb are reduced, and the heating rate during heat treatment is late, 10000° C./min. (166 K/sec.) or less. It is not possible to obtain a fine nanocrystalline structure with an average crystal grain size of 50 nm or less which is necessary to exhibit excellent magnetic properties.

In the method described in Patent Document 1, the average crystal grain size is approximately 100 min. Thus, in the embodiment of Patent Document 1, an iron loss at 20 kHz and 0.2 T is 10 W/kg or more. As shown in Table 1 of Patent Document 1, it can be seen that the magnetic core loss of the invention example is significantly deteriorated compared to the nanocrystalline material of the reference example. The Fe-based nanocrystalline soft magnetic alloy of Patent Document 1 can be used in product applications that place importance on saturation magnetic flux density, but is not suitable for applications that require a material excellent in magnetic core loss.

Patent Document 2 discloses a nanocrystalline alloy ribbon of 1.4 T or more. However, since the alloy is heat treated under tension, anisotropy is imparted to the alloy. Further, the magnetic permeability is 3000 or less, and the remanence ratio Jr/Js (Br/Bs) is low, 0.1 or less. For this reason, the alloy of Patent Document 2 is not suitable for use in any products other than those requiring low magnetic permeability. In addition, since the alloy ribbon is not constrained during the heat treatment, wrinkles and streaks are likely to appear in the ribbon during nanocrystallization. Properties such as thickness deviation and space factor are likely to deteriorate. Furthermore, portions with wrinkles and streaks can become extremely brittle and may break due to tension.

The present disclosure provides a nanocrystalline alloy ribbon having excellent magnetic properties such as high saturation magnetic flux density and high magnetic permeability, a nanocrystalline alloy ribbon having low magnetostriction, low loss, and isotropy, and a nanocrystalline alloy ribbon with reduced wrinkles and streaks and high space factor, or a magnetic sheet using the foregoing ribbons.

### Means for Solving the Problems

The nanocrystalline alloy ribbon according to a first aspect of the present disclosure is represented by a composition formula: (Fe₁₋ₓAₓ)ₐSi_{b}B_{c}Cu_{d}Mₑ, wherein A is at least one type of Ni and Co, M is at least one type of element selected from a group consisting of Nb, Mo, V, Zr, Hf and W, and in at %, 75.0≤a≤81.0, 9.0≤b≤18.0, 5.0≤c≤10.0, 0.02≤d≤1.2, 0.1≤e≤1.5, and 0≤x≤0.1 are satisfied, an αFe crystal phase having an average crystal grain size of 50 nm or less accounts for 40% or more by volume fraction, a saturation magnetic flux density is 1.36 T or more, a ratio Br/B₈₀₀₀ of a residual magnetic flux density Br to a magnetic flux density B₈₀₀₀ at a magnetic field of 8000 A/m is 0.20 or more, and a maximum magnetic permeability is 4000 or more.

The magnetic sheet according to a second aspect of the present disclosure comprises a nanocrystalline alloy ribbon of the present disclosure, and an adhesive layer with a support formed in a ribbon shape and an adhesive provided on at least one of a first surface and a second surface of the support. The nanocrystalline alloy ribbon is attached to the adhesive of the adhesive layer, and the adhesive layer has a thickness of 1 to 10 μm.

The adhesive layer may be a magnetic sheet with the adhesive provided on the first surface and the second surface, and a plurality of the nanocrystalline alloy ribbons formed in multiple layers with the adhesive layer in between.

### Effects of the Invention

According to the present disclosure, a nanocrystalline alloy ribbon having excellent magnetic properties such as high saturation magnetic flux density and high magnetic permeability can be obtained. Further, a nanocrystalline alloy ribbon with low magnetostriction, low loss, and isotropy can be obtained. Also, a nanocrystalline alloy ribbon with reduced wrinkles and streaks and high space factor can be obtained. In addition, a magnetic sheet using these nanocrystalline alloy ribbons can be provided.

### BRIEF DESCRIPTION OF THE DRAWINGS

FIG. 1 is a conceptual diagram showing one embodiment of a heat treatment method of the present disclosure.

FIG. 2 is a cross-sectional view for explaining a configuration of a magnetic sheet of the present disclosure.

FIG. 3 is a cross-sectional view for explaining a configuration of the magnetic sheet of the present disclosure.

FIG. 4 is a schematic diagram explaining a method for manufacturing the magnetic sheet of the present disclosure.

FIG. 5 is a cross-sectional view for explaining a configuration of a laminate supplied from a first unwinding roll.

FIG. 6 is a cross-sectional view for explaining a configuration of the laminate supplied from the first unwinding roll and from which a resin sheet has been peeled off.

FIG. 7 is a cross-sectional view for explaining a configuration of a nanocrystalline alloy ribbon supplied from a second unwinding roll.

FIG. 8 is a cross-sectional view for explaining a configuration of the magnetic sheet of the present disclosure.

### MODE FOR CARRYING OUT THE INVENTION

Hereinafter, embodiments of the present disclosure will be described in detail. The present disclosure is not limited to the embodiments below, and can be practiced with appropriate modifications within the scope of the spirit of the present disclosure.

A nanocrystalline alloy ribbon of the present disclosure is represented by a composition formula: (Fe₁₋ₓAₓ)ₐSi_{b}B_{c}Cu_{d}Mₑ, where A is at least one type of Ni and Co, M is at least one type of element selected from a group consisting of Nb, Mo, V, Zr, Hf and W, and in a %, 75.0≤a≤81.0, 9.0≤b≤18.0, 5.0≤c≤10.0, 0.02≤d≤1.2, 0.1≤e≤1.5, and 0≤x≤0.1 are satisfied.

Detailed description on a composition of the nanocrystalline alloy ribbon of the present disclosure will be given below.

A content of Fe (iron) is 75.0% or more and 81.0% or less in at %.

By setting the Fe content to 75.0% or more, high saturation magnetic flux density can be obtained. The Fe content is preferably 76% or more, and more preferably 77% or more.

If the Fe content exceeds 81.0%, then it becomes difficult to reduce magnetostriction. Therefore, the Fe content is set to 81.0% or less. The Fe content is preferably 80% or less, and more preferably 78% or less.

In addition, apart of Fe may be substituted with at least one type of element selected from Ni and Co. In(Fe₁₋Aₓ), A is at least one type of element selected from Ni and Co, and x is 0.1 or less. When a part of Fe is substituted with at least one type of element selected from Ni and Co, a in (Fe₁₋ₓAₓ)ₐ falls within a range of 75.0%≤a≤81.0%, A content a in (Fe₁₋ₓAₓ) is preferably 76% or more, and more preferably 77% or more. Also, the content a is preferably 80% or less, and more preferably 78% or less.

A content of Si (silicon) is 9.0% or more and 18.0% or less in at %.

By setting the Si content to 9.0% or more, low magnetostriction can be achieved. The Si content is preferably 10% or more, more preferably 13% or more, and still more preferably 15% or more. If the Si content exceeds 18.0%, then amorphous forming ability decreases, crystallization occurs during casting, and soft magnetic properties significantly deteriorate. The Si content is preferably 17.0% or less, and more preferably 16.5% or less.

A content of B (boron) is 5.0% or more and 10.0% or less in at %.

When the B content is less than 5.0, it becomes difficult to form amorphous. Thus, the B content is set to 5.0% or more. The B content is preferably 5.5% or more, and more preferably 6.0% or more.

If the B content exceeds 10.0%, then the Fe content and the Si content decrease. As a result, the saturation magnetic flux density is reduced and the magnetostriction increases. Therefore, the B content is set to 10.0% or less. The B content is preferably 8.5% or less, more preferably 7.5% or less, and still more preferably 7.0% or less.

A content of Cu (copper) is 0.02% or more and 1.2% or less in at %.

Including Cu makes it easier to obtain a uniform, fine nanocrystalline structure. When the Cu content is less than 0.02%, it becomes difficult to achieve an average grain diameter of 50 nm or less. Therefore, the Cu content is set to 0.02% or more. The Cu content is preferably 0.05% or more, more preferably 0.2% or more, still more preferably 0.3% or more, and still more preferably 0.5% or more.

When the Cu content exceeds 1.2%, embrittlement is likely to occur, and the saturation magnetic flux density is reduced. Therefore, the Cu content is set to 1.5% or less. The Cu content is preferably 1.0% or less, more preferably 0.75% or less, and still more preferably 0.65% or less.

The M element is at least one type of element selected from the group consisting of Nb, Mo, V, Zr, Hf and W. A content of M element is 0.1% or more and 1.5% or less in at %.

Including the M element allows shifting of a deposition starting temperature of a FeB compound, which significantly deteriorates soft magnetic properties, to a higher temperature. This makes it possible to widen the difference between a bccFe (αFe) crystallization starting temperature and the FeB deposition starting temperature, have the effect of widening a range of optimal heat treatment temperatures, and reduce heat treatment conditions. The content of M element is preferably 0.3% or more, and more preferably 0.4% or more.

The M element is expensive. If the content of M element increases, then the price of the nanocrystalline alloy ribbon increases. Thus, it is preferable that the content of M element is small. Accordingly, the content of M element is set to 1.5% or less. The content of M element is preferably 1.0% or less, more preferably 0.9% or less, still more preferably 0.8% or less, still more preferably 0.7% or less.

The nanocrystalline alloy ribbon of the present disclosure may contain C (carbon). C has the effect of improving the flow of molten metal, and improves castability when included in a small amount. On the other hand, if a large amount of C is added, the ribbon becomes brittle. Therefore, it is preferable that the C content is 1% by mass or less. In addition, C can be included as an impurity of raw materials.

The raw material price increases as the C content decreases. Therefore, it is preferable to allow the C content of 0.01% by mass or more. In order to increase the effect of C, it is preferable that the C content is 0.1% by mass or more.

The nanocrystalline alloy ribbon of the present disclosure may contain impurities other than the aforementioned elements.

Examples of impurities include S (sulfur), O (oxygen), N (nitrogen), Cr, Mn, P, Ti, Al, and so on. For example, a content of S is preferably 200 ppm by mass or less, a content of O is preferably 5000 ppm by mass or less, and a content of N is preferably 1000 ppm by mass or less.

A content of P is preferably 2000 ppm by mass or less. It is preferable that the total content of these impurities is 0.5% by mass or less. Furthermore, within the aforementioned range, elements equivalent to impurities may be added.

A preferred embodiment of a method for manufacturing of the nanocrystalline alloy ribbon of the present disclosure will be described.

The nanocrystalline alloy ribbon of the present disclosure can be obtained as follows. A molten alloy having the aforementioned alloy composition is ejected onto a rotating cooling roller, and rapidly cooled and solidified on the cooling roller to obtain an alloy ribbon. Then, the alloy ribbon is heat treated to obtain the nanocrystalline alloy ribbon.

The alloy ribbon obtained by rapidly cooling and solidifying the molten alloy has an amorphous alloy structure, and is a non-crystalline alloy ribbon. By heat treating the non-crystalline alloy ribbon, the nanocrystalline alloy ribbon can be obtained. The non-crystalline alloy ribbon obtained by rapidly cooling and solidifying the molten alloy may have a crystalline phase including fine crystals.

In order to obtain the molten alloy, a plurality of materials, that is, element sources (pure iron, ferroboron, ferrosilicon, etc.) to achieve a desired alloy composition are mixed together. The plurality of materials are then heated in an induction heating furnace, and melted to become a molten alloy when the temperature reaches or exceeds the melting point.

The alloy ribbon can be obtained by ejecting the molten alloy from a slit-shaped nozzle having a specified shape onto a rotating cooling roller, and rapidly cooling and solidifying the molten alloy on the cooling roller. The cooling roller may have an outer diameter of 350 to 1000 mm, a width of 100 to 400 mm, and a peripheral speed of rotation of 20 to 35 m/sec. The cooling roller includes an internal cooling mechanism (such as water cooling) for inhibiting an increase in temperature at its outer circumferential portion.

The outer circumferential portion of the cooling roller is preferably made of a Cu alloy having a thermal conductivity of 120 W/(m·K) or more. By setting the thermal conductivity of the outer circumferential portion to 120 W/(m·K) or more, the cooling rate when the molten alloy is cast into an alloy ribbon can be increased.

This makes it possible to inhibit embrittlement of the alloy ribbon, thicken the alloy ribbon (increase the thickness), and inhibit surface crystallization during casting. Accordingly, it is possible to inhibit coarsening of crystal grains during heat treatment, and reduce iron loss.

The thermal conductivity of the outer circumferential portion is preferably 150 W/(m·K) or more, and more preferably 180 W/(m·K) or more.

The outer circumferential portion of the cooling roller indicates a portion where the molten alloy may contact. The outer circumferential portion may have a thickness of around 5 to 15 mm, and the inside thereof may be made of a structural material that maintains a roller structure.

By heat treating the non-crystalline alloy ribbon produced by the aforementioned rapid quenching method (a method for obtaining an alloy ribbon by rapidly cooling a molten alloy), the nanocrystalline alloy ribbon can be obtained.

A preferred embodiment of the heat treatment method in the present disclosure will be described below.

In the present disclosure, it is preferable that the heat treatment is preferably performed at a temperature of 500 to 700° C. The heating rate is preferably 15000° C./min. or more.

In the heat treatment of the present disclosure, it is preferable that the non-crystalline alloy ribbon is heat treated by bringing the non-crystalline alloy ribbon into contact with a heating body. The heating body is set to a desired temperature (heat treatment temperature: 500 to 700° C.), and it is preferable that the heat treatment is performed by bringing the non-crystalline alloy ribbon into contact with the heating body set to the desired temperature.

At this time, it is preferable that the contact time (retention time) between the non-crystalline alloy ribbon and the heating body is 0.1 to 30 seconds. The lower limit of the contact time is preferably 0.2 seconds. The upper limit of the contact time is preferably 10 seconds, more preferably 5 seconds, and most preferably 2 seconds. In order to achieve high speed and stabilization so as to improve mass productivity, it is preferable that the contact time is set to 0.2 to 2 seconds.

In the heat treatment of the present disclosure, it is preferable that the heating rate is set to 30000° C./min. or more. An upper limit of the heating rate can be determined by installation capacity of a heat treatment device, temperatures of the heating body and a ribbon holding member, and a contact state between the heating body and ribbon holding member and the ribbon, but is practically around 240000° C./min., and preferably 100000° C./min.

By applying a magnetic field and a tension during the heat treatment, properties such as magnetic permeability and B80_{L}/B80_{W} can be adjusted.

In the present disclosure, when the heat treatment is performed by bringing the non-crystalline alloy ribbon into contact with the heating body, it is preferable that the non-crystalline alloy ribbon is heat treated while being pressed against the heating body.

As a method for heat treating the non-crystalline alloy ribbon while being pressed against the heating body, the ribbon holding member can be brought into contact with a surface of the non-crystalline alloy ribbon opposite to a surface that contacts the heating body, so that the non-crystalline alloy ribbon is pressed against the heating body. The ribbon holding member is configured to pressurize the non-crystalline alloy ribbon, so that the non-crystalline alloy ribbon can be pressed against the heating body. The ribbon holding member is preferably a flexible member.

It is preferable that the flexible member is a metal member. The flexible member is a member that can be deformed along the roller.

The ribbon holding member may be a belt or a roller.

An example of the heat treatment method of the present disclosure will be described with reference to the drawings.

FIG. 1 is a conceptual diagram showing one embodiment of the heat treatment method of the present disclosure.

The heat treatment method shown in FIG. 1 includes a heating roller 2 serving as a heating body, a ribbon holding metal belt 3 (ribbon holding member), and rollers 4, 5 supporting the ribbon holding metal belt 3. The ribbon holding metal belt 3 (ribbon holding member) is an example of a configuration (element) that presses the non-crystalline alloy ribbon (hereinafter, also referred to as a ribbon) 1 against the heating roller 2 serving as a heating body.

In the heat treatment method, the non-crystalline alloy ribbon 1 is passed between the heating roller 2 (heating body) and the ribbon holding metal belt 3, and the non-crystalline alloy ribbon 1 is heated while being pressed against the heating body (heating roller 2). Each arrow in FIG. 1 indicates movement of the corresponding portion. The heating roller 2 and the rollers 4, 5 are cylindrical, and have a rotating structure. By these rollers, the non-crystalline alloy ribbon 1 is heated while being conveyed and pressed against the heating roller 2.

The non-crystalline alloy ribbon 1 after heated by the heating roller 2 becomes a nanocrystalline alloy ribbon.

It is preferable that heating rollers that can be heated are used as the rollers 4, 5. It is preferable that the ribbon holding metal belt 3 is heated by these rollers before contacting the non-crystalline alloy ribbon 1. When the rollers 4, 5 are heating rollers, it is preferable that a temperature of the ribbon holding metal belt 3 (temperature when the ribbon holding metal belt 3 is bought into contact with the non-crystalline alloy ribbon 1) is set to be equal to, or slightly lower than, the heating temperature of the non-crystalline alloy ribbon 1.

Temperatures of the rollers 4, 5 may be set to temperatures that make the temperature of the ribbon holding metal belt 3 appropriate. For example, it is also desirable that the temperatures of the rollers 4, 5 are set to be approximately 50° C. higher than the temperature of the heating body. For the temperatures of the ribbon holding metal belt 3 and the rollers 4, 5, temperatures suitable for heat treatment of the non-crystalline alloy ribbon 1 can be selected.

The ribbon holding metal belt 3 is an example of a flexible member, and the flexible member is preferably a metal member from the viewpoint of flexibility and strength. For example, it is more preferable to use a material excellent in heat resistance such as heat-resistant stainless steel and nickel-based super heat-resistant alloy.

According to the aforementioned heat treatment method, the flexible member (ribbon holding metal belt 3) is pressed against the surface of the non-crystalline alloy ribbon 1 opposite to the surface that contacts the heating body. As a result, the non-crystalline alloy ribbon 1 is pressed against the heating body (heating roller 2). It is preferable that the non-crystalline alloy ribbon 1 is in close contact with the heating roller 2 by the ribbon holding metal belt 3, and the non-crystalline alloy ribbon 1, the ribbon holding metal belt 3, and the heating roller 2 move as one.

The heating roller 2 is a heating body for directly contacting and heating the non-crystalline alloy ribbon. The non-crystalline alloy ribbon 1 is brought into contact with a part of an outer peripheral surface (a part of the circumferential region) of the cylindrical heating roller 2, and heated. The heating roller 2 may have a driving force to convey the non-crystalline alloy ribbon.

Both of the rollers 4, 5 or only one of the rollers 4, S may be used as rollers or a roller for driving the ribbon holding metal belt 3. The roller 5 may be provided with a driving force, and the roller 4 may be mechanically subordinate to the roller 5. In this way, complex control such as electrically synchronous operation of the rollers 4 and 5 can be avoided. Furthermore, correction of synchronization errors between the roller 4 and the roller 5 due to differences in thermal expansion between the roller 4 and the roller 5 becomes unnecessary.

The heating roller 2 is an example of a heating body having a convex surface which the non-crystalline alloy ribbon 1 contacts to be heated. Also, the term “convex surface” means a raised surface toward the non-crystalline alloy ribbon side. For example, the heating roller 2, like the roller shown in FIG. 1, may have a curved surface formed by a cylindrical (columnar) side surface, or a curved surface formed as a part of a member, such as a curved surface portion of an approximately D-shaped member. The heating roller 2 may have any shape that allows the non-crystalline alloy ribbon to follow and ensures sufficient contact. The heating body of the present disclosure may be configured not to rotate, and may be configured such that the ribbon moves (slides) on the heating body.

In the nanocrystalline alloy ribbon of the present disclosure, the αFe crystal phase having an average crystal grain size of 50 nm or less accounts for 40% or more by volume fraction.

In addition, the nanocrystalline alloy ribbon of the present disclosure has a saturation magnetic flux density of 1.36 T or more, a ratio Br/B₈₀₀₀ of a residual magnetic flux density Br to a magnetic flux density B₈₀₀₀ in a magnetic field of 8000 A/m of 0.20 or more, and a maximum magnetic permeability of 4000 or more. The saturation magnetic flux density is preferably 1.37 T or more, and more preferably 1.40 T or more. The maximum magnetic permeability is preferably 5000 or more.

It is preferable that the nanocrystalline alloy ribbon of the present disclosure has a ratio (B80_{L}/B80_{W}) of the magnetic flux density B80_{L}, when the magnetic field of 80 A/m is applied in a longitudinal direction of the nanocrystalline alloy ribbon to the magnetic flux density B80_{W} when the magnetic field of 80 A/m is applied in a width direction orthogonal to the longitudinal direction, of 0.60 to 1.40, and that both B80_{L}, and B80_{W} are 0.4 T or more. The ratio (B80_{L}/B80_{W}) is more preferably 0.70 to 1.30. Also, both B80_{L} and B80_{W} are more preferably 0.5 T or more.

The nanocrystalline alloy ribbon of the present disclosure preferably has a saturation magnetostriction of 7 ppm or less, and more preferably 5 ppm or less.

The saturation magnetostriction is most preferably 0 ppm.

The nanocrystalline alloy ribbon having a saturation magnetostriction of approximately 0 ppm (−2.0 ppm or more and 2.0 ppm or less) can be obtained when the composition is represented by the formula (Fe₁₋ₓAₓ)ₐSi_{b}B_{c}Cu_{d}Mₑ, where A is at least one type of Ni and Co, M is at least one type of element selected from a group consisting of Nb, Mo, V, Zr, Hf and W, and in at %, 75.0≤a≤77.0, 15.0≤b≤18.0, 5.0≤c≤7.5, 0.02≤d≤1.2, 0.6≤e≤1.5, and 0≤x≤0.1 are satisfied. In this case, it is preferable that 0.190≤b/a≤0.225 is satisfied.

The nanocrystalline alloy ribbon of the present disclosure preferably has a thickness of 25 μm or less, and more preferably 20 μm or less. The thickness is preferably 5 μm or more, and more preferably 10 μm or more. The width is preferably 5 mm or more, more preferably 20 mm or more, and still more preferably 30 mm or more.

The nanocrystalline alloy ribbon of the present disclosure preferably has a wrinkle height of 0.15 mm or less, more preferably 0.10 mm or less, and still more preferably 0.08 mm or less.

The nanocrystalline alloy ribbon of the present disclosure preferably has a space factor of 68.0% or more, more preferably 70% or more, and still more preferably 75% or more.

The space factor can be measured by the following method compliant with JIS C 2534:2017.

Twenty sheets of ribbons cut into a length of 120 mm are stacked on a flat sample stage, and a flat anvil having a diameter of 16 mm is placed on the stacked ribbons with a pressure of 50 kPa. Then, the height is measured at 10 mm intervals in the width direction. The maximum height at the time is set to hmax (μm) and a space factor LF is calculated using the following formula.

$$LF ( \% ) = sample weight ( g ) / density ( g / {cm}^{3} ) / hmax ( µm ) / sample length ( 240 cm ) / ribbon width ( cm ) \times 10000$$

In this case, density (g/cm³) is a density of the alloy ribbon after the heat treatment. The density can be 7.4 g/cm³.

The nanocrystalline alloy ribbon of the present disclosure is suitable for use in magnetic cores and shielding materials for electronic components, motors, and the like. This makes it possible to obtain magnetic cores and sheet materials having excellent magnetic properties.

The nanocrystalline alloy ribbon of the present disclosure, for example, can form a magnetic sheet that can be used as a magnetic sheet for contactless charging.

The magnetic sheet of the present disclosure comprises a nanocrystalline alloy ribbon, a support formed in a ribbon shape, and an adhesive layer having an adhesive provided at least one of a first surface and a second surface of the support, the nanocrystalline alloy ribbon being attached to the adhesive of the adhesive layer, and the adhesive layer having a thickness of 1 to 10 μm. It is preferable that the adhesive layer has an adhesive on both surfaces of the support.

It is also preferable that the magnetic sheet is formed by laminating a plurality of nanocrystalline alloy ribbons with the adhesive layer in between. Specifically, a plurality of magnetic sheets, each having a nanocrystalline alloy ribbon with an adhesive layer bonded to one side thereof, are prepared. A magnetic sheet having nanocrystalline alloy ribbons laminated thereon can be formed by attaching the nanocrystalline alloy ribbon of another magnetic sheet to the side of the adhesive layer of a first magnetic sheet on which the nanocrystalline alloy ribbon is not attached. In this case, the number of layers of the nanocrystalline alloy ribbons can be appropriately selected in order to obtain desired properties.

It is preferable that the magnetic sheet of the present disclosure, when a sample is taken from the magnetic sheet having nanocrystalline alloy ribbons laminated thereon and measured, has an iron loss of 2000 kW/m³ or less at 128 kHz and 0.2 T, and a real part of complex permeability of 1500 or more at 128 kHz and 0.03 V.

The iron loss is preferably low, more preferably 1800 kW/m³ or less, still more preferably 1700 kW/m³ or less, and still more preferably 1500 kW/m³ or less.

When the magnetic sheet of the present disclosure is used for contactless charging applications, the amount of magnetic flux generated increases as the charging output increases. In order to inhibit magnetic saturation of the magnetic sheet and reduce eddy current loss, it is preferable that cracks are formed in the nanocrystalline alloy ribbon.

It is preferable that the magnetic sheet of the present disclosure, when a sample is taken from the magnetic sheet in which nanocrystalline alloy ribbons having cracks formed thereon are laminated and measured, has an iron loss of 2000 kW/m³ or less at 128 kHz and 0.2 T, and a real part of complex permeability of 400 to 3000 at 128 kHz and 0.03 V.

### Example 1

In Example 1, element sources were mixed so that the alloy composition was Fe_{76.4}Si₁₆B_{6.5}Cu_{0.6}Nb_{0.5}, the mixture was heated to 1350° C. to prepare a molten alloy, and the molten alloy was ejected onto a cooling roller having an outer diameter of 400 mm and a width of 200 mm that rotates at a peripheral speed of 30 m/s. The molten alloy was rapidly cooled and solidified on the cooling roller to prepare a non-crystalline alloy ribbon. The outer circumferential portion of the cooling roller is made of a Cu alloy having a thermal conductivity of 150 W/(m·K), and includes an internal cooling mechanism for controlling the temperature of the outer circumferential portion.

This non-crystalline alloy ribbon was heat treated under conditions of a heating rate of 6° C./min., a heat treatment temperature of 470° C., and a retention time of 1 hour to prepare a sample (Reference Example 1), and was heat treated under conditions of a heating rate of 79200° C./min., a heat treatment temperature of 660° C., and a retention time of 1.2 seconds to prepare a sample (Example 1). In the heat treatment of Example 1, a heat treatment method shown in FIG. 1 was used. The samples of Example 1 and Reference Example 1 after the heat treatment were nanocrystalline alloy ribbons.

The nanocrystalline alloy ribbons of Example 1 and Reference Example 1 had a width of 50 mm and a thickness of 16.4 μm.

Table 1 shows the average crystal grain size, the iron loss at 20 kHz and 0.2 T, Br/B₈₀₀₀, and the maximum magnetic permeability for Example 1 and Reference Example 1. B₈₀₀₀(Bs) of Example 1 and Reference Example 1 were equivalent to 1.41 T.

In Example 1, by setting the heating rate to 15000° C./min. or more, it was possible to have the average crystal grain size of 50 nm or less. The iron loss at 20 kHz and 0.2 T was 10 W/kg or less, which was also excellent. Br/B₈₀₀₀ was 0.20 or more, and the maximum magnetic permeability indicated 4000 or more. In Example 1, a nanocrystalline alloy ribbon having high saturation magnetic flux density, low loss, and high magnetic permeability was achieved. The measurement method will be described in Example 2.

TABLE 1

| | | Heat | | | Average | | | |
|---|---|---|---|---|---|---|---|---|
| | Heating | treatment | | | crystal grain | Iron loss | | Maximum |
| | rate | temp. | Retention | | size | 20 kHz, 0.2 T | Br/B₈₀₀₀ | magnetic |
| | ° C./min. | ° C. | time | | nm | W/kg | (Br/Bs) | permeability |
| Example 1 | 79200 | 660 | 1.2 | sec. | 30.9 | 7.6 | 0.47 | 20400 |
| Ref. Ex. 1 | 6 | 470 | 20 | min. | 83.4 | 30.5 | 0.87 | 12000 |

### Example 2

In Example 2, element sources were mixed so as to obtain each composition shown in Table 2. The mixture was heated to 1350° C. to prepare a molten alloy. The molten alloy was ejected onto a cooling roller having an outer diameter of 400 mm and a width of 200 mm that rotated at a peripheral speed of 30 m/sec., and was rapidly cooled and solidified on the cooling roller to prepare a non-crystalline alloy ribbon.

Table 3 shows the width and thickness of the non-crystalline alloy ribbons. An outer circumferential portion of the cooling roller was made of a Cu alloy having a thermal conductivity of 150 W/(m·K), and includes an internal cooling mechanism for controlling the temperature of the outer circumferential portion.

Heat treatment was performed using the non-crystalline alloy ribbons made of materials shown in Table 2, under the conditions shown in Table 3. The evaluation results are shown in Tables 3 and 4. Blank fields in the tables mean that no measurement was performed.

TABLE 2

| | Composition (at%) | | | | |
|---|---|---|---|---|---|
| No. | Fe | Si | B | Cu | Nb |
| 1 | 75.7 | 15.3 | 7.0 | 1.0 | 1.0 |
| 2 | 77.3 | 12.0 | 9.0 | 0.7 | 1.0 |
| 3 | 79.9 | 9.5 | 9.0 | 0.7 | 1.0 |
| 4 | 76.8 | 14.0 | 8.0 | 0.7 | 0.5 |
| 5 | 75.9 | 15.5 | 7.0 | 0.8 | 0.8 |
| 6 | 76.9 | 14.2 | 7.8 | 0.7 | 0.4 |
| 7 | 76.9 | 16.0 | 6.0 | 0.6 | 0.5 |
| 8 | 76.0 | 16.0 | 6.0 | 1.0 | 1.0 |
| 9 | 76.4 | 16.0 | 6.0 | 0.6 | 1.0 |
| 10 | 76.4 | 16.0 | 6.5 | 0.8 | 0.5 |
| 11 | 76.8 | 16.0 | 6.5 | 0.3 | 0.4 |
| 12 | 76.4 | 16.1 | 6.0 | 0.05 | 1.5 |
| 13 | 76.4 | 16.6 | 6.0 | 0.05 | 1.0 |

TABLE 3

| | | | | Heat | | Average | | Saturation | |
|---|---|---|---|---|---|---|---|---|---|
| | | | Heating | treatment | Retention | crystal | Volume | magnetic | Maximum |
| | Width | Thickness | rate | temp. | time | grain size | fraction | flux density | magnetic |
| No. | mm | μm | ° C./min. | ° C. | sec. | nm | % | T | permeability |
| 1 | 33 | 14.6 | 74400 | 620 | 0.6 | 27.3 | 92.6 | 1.40 | 10100 |
| 2 | 33 | 16.5 | 79200 | 660 | 1.2 | 29.0 | 67.5 | 1.47 | 5173 |
| 3 | 33 | 16.0 | 76800 | 640 | 1.2 | 30.6 | 77.8 | 1.59 | 10323 |
| 4 | 33 | 15.4 | 79200 | 660 | 0.6 | 35.1 | 81.8 | 1.48 | 7800 |
| 5 | 50 | 15.1 | 79200 | 660 | 1.8 | 28.4 | 86.6 | 1.37 | 5600 |
| 6 | 50 | 16.5 | 79200 | 660 | 1.2 | 34.9 | 81.9 | 1.45 | 9900 |
| 7 | 33 | 16.1 | 76800 | 640 | 0.4 | 27.9 | 87.7 | 1.42 | 12264 |
| 8 | 25 | 15.3 | 74400 | 620 | 0.9 | 26.7 | 87.8 | 1.37 | 22549 |
| 9 | 50 | 15.9 | 74400 | 620 | 0.6 | 27.4 | 87.4 | 1.38 | 10448 |
| 10 | 50 | 16.4 | 79200 | 660 | 1.2 | 30.9 | 87.5 | 1.41 | 20400 |
| 11 | 50 | 16.0 | 79200 | 660 | 1.2 | 32.3 | 85.2 | 1.42 | 19505 |
| 12 | 25 | 16.6 | 61600 | 680 | 0.4 | 27.7 | 87.8 | 1.37 | 52965 |
| 13 | 25 | 17.3 | 76800 | 640 | 0.6 | 25.8 | 91.0 | 1.39 | 53799 |

TABLE 4

| | | | | Iron loss | | Saturation | Wrinkle | Space |
|---|---|---|---|---|---|---|---|---|
| | | | | 20 kHz, 0.2 T | Br/B8000 | magnetostriction | height | factor |
| No. | B80_{L} | B80_{W} | B80_{L}/880_{W} | W/kg | (Br/Bs) | ppm | mm | % |
| 1 | 0.64 | 0.62 | 1.02 | | 0.24 | 1.1 | 0.061 | 79.8 |
| 2 | 0.52 | 0.42 | 1.24 | | 0.24 | 5.9 | 0.047 | 79.6 |
| 3 | 0.74 | 0.88 | 0.84 | | 0.56 | 7.9 | 0.066 | 79.4 |
| 4 | 0.87 | 0.96 | 0.91 | 7.8 | 0.29 | 4.4 | 0.031 | 74.2 |
| 5 | 0.77 | 0.87 | 0.89 | | 0.22 | 3.2 | 0.047 | 72.1 |
| 6 | 0.76 | 0.66 | 1.15 | | 0.3 | 4.7 | 0.031 | 73.3 |
| 7 | 0.84 | 0.76 | 1.11 | | 0.26 | 2.8 | 0.029 | 76.7 |
| 8 | 0.68 | 0.55 | 1.24 | | 0.24 | 0.5 | 0.046 | 75.4 |
| 9 | 0.66 | 0.59 | 1.13 | 7.8 | 0.21 | 1.7 | 0.035 | 71.4 |
| 10 | 0.93 | 0.91 | 1.03 | 7.5 | 0.47 | 3.0 | 0.025 | 70.2 |
| 11 | 1.15 | 1.04 | 1.11 | | 0.35 | 3.1 | 0.051 | 70.5 |
| 12 | 0.81 | 0.62 | 1.31 | | 0.37 | −0.4 | 0.055 | 74.8 |
| 13 | 0.73 | 0.57 | 1.28 | | 0.30 | 0 | 0.126 | 72.6 |

### [Average Crystal Grain Size]

The average crystal grain size was determined from the Scherrer formula using the integral width of the diffraction peak from the (110) plane in the X-ray diffraction pattern obtained from the X-ray diffraction experiment. The integral width of the diffraction peak from the (110) plane is determined by peak resolution using a pseudo-Voigt function for the diffraction pattern. If the average grain diameter is D, the integral width is β, the diffraction angle is 0, the Scherrer constant is K, and the wavelength of X-rays is λ, then D can be determined from the Scherrer formula (Formula 1) given below.

In this case, however, it was assumed that the wavelength of X-rays λ=0.154050 nm, and the Scherrer constant K=1.333. The integral width was corrected to be narrowed by the amount of the diffraction line width due to the device.

$$D = \frac{K λ}{β cos θ} \qquad [ Formula 1 ]$$

### [Volume Fraction]

The volume fraction is a volume fraction of nanocrystals, and the portion other than the nanocrystals is a non-crystalline portion.

The volume fraction is determined as a ratio of the integral intensity of the diffraction peak from the (110) plane of Fe to the integral intensity of the halo pattern. The integral intensity of the halo pattern is integral intensity of the diffraction peak from the (110) plane of Fe plus the integral intensity near 2θ=44°. The integral intensities of the peak exhibited by the nanocrystals and the halo pattern exhibited by the amorphous are determined by peak resolution using a pseudo-Voigt function for the X-ray diffraction pattern.

The volume fraction V is determined from a formula (Formula 2) below where Ic is the integral intensity of the (110) peak of nanocrystals, and Ia is the integral intensity of the halo pattern near 2θ=44°. In a case of the composition of the present example, however, the peaks of the integral intensities of Fe and Fe₂B overlap, and are difficult to separate. Thus, Ic and Ia may include the integral intensities of deposited Fe₂B, albeit in a small amount.

$$V = \frac{Ic}{Ic + Ia} \times 100 \qquad [ Formula 2 ]$$

### [Saturation Magnetic Flux Density Bs]

The saturation magnetic flux density Bs is obtained by applying a magnetic field of 8000 A/m to a heat treated nanocrystalline alloy ribbon (single sheet sample) using a DC magnetization characteristics test equipment manufactured by Metron Giken Co., Ltd., and measuring the maximum magnetic flux density at that time. The nanocrystalline alloy ribbon of the present disclosure has a property of being relatively easy to saturate, and thus saturates when a magnetic field of 8000 A/m is applied. Since B₈₀₀₀ and the saturation magnetic flux density Bs have approximately the same value, the saturation magnetic flux density Bs is represented by B₈₀₀₀.

### [Maximum Magnetic Permeability]

The maximum magnetic permeability was determined by applying a magnetic field of 800 A/in to a heat treated nanocrystalline alloy ribbon (single sheet sample) using a DC magnetization characteristics test equipment manufactured by Metron Giken Co., Ltd., and measuring the magnetic permeability against the magnetic field H at that time. The maximum magnetic permeability at the time is applied.

### [Magnetic Flux Density BRO]

A magnetic field of 80 A/m was applied in each of a longitudinal direction (casting direction) of the nanocrystalline alloy ribbon and a width direction orthogonal to the longitudinal direction by a DC magnetization characteristics test equipment manufactured by Metron Giken Co., Ltd., and the respective maximum magnetic flux densities at that time were set to B80_{L} and B80_{W}. Then, a ratio B80_{L}/B80_{W} was calculated to evaluate isotropy.

### [Saturation Magnetostriction]

A magnetic field of 5 kOe was applied, using an electromagnet, to a sample (nanocrystalline alloy ribbon) with a strain gauge manufactured by Kyowa Electronic Instruments Co., Ltd. attached thereto. Then, the electromagnet was rotated 360°, and the maximum change in elongation and contraction of the sample caused when the direction of the magnetic field applied to the sample was changed 360° was measured from the change in electrical resistance value of the strain gauge. Saturation magnetostriction=⅔×maximum change.

Table 5 shows a relationship between the saturation magnetostriction and Si/Fe (at % ratio). As shown in Table 5, when the composition is represented by the formula (Fe1-xAx)aSibBcCudMe, where A is at least one type of Ni and Co, M is at least one type of element selected from a group consisting of Nb, Mo, V, Zr, Hf and W, and in at %, 75.0≤a≤77.0, 15.0≤b≤18.0, 5.0≤c≤7.5, 0.02≤d≤1.2, 0.6≤e≤1.5, and 0≤x≤0.1 are satisfied, a nanocrystalline alloy ribbon having a saturation magnetostriction of approximately 0 ppm (−2.0 ppm or more and 2.0 ppm or less) was obtained. At this time, 0.190≤b/a≤0.225 is satisfied.

TABLE 5

| | | | | | | | Saturation |
|---|---|---|---|---|---|---|---|
| | Composition (at %) | | | | | | magnetostriction |
| No. | Fe | Si | 8 | Cu | Nb | Si/Fe | ppm |
| 7 | 76.4 | 16.0 | 6.5 | 0.6 | 0.5 | 0.209 | 2.8 |
| 10 | 76.9 | 16.0 | 6.0 | 0.6 | 0.5 | 0.208 | 3.0 |
| 2 | 77.3 | 12.0 | 9.0 | 0.7 | 1.0 | 0.155 | 5.9 |
| 3 | 79.9 | 9.5 | 9.0 | 0.7 | 1.0 | 0.119 | 7.9 |
| 4 | 76.8 | 14.0 | 8.0 | 0.7 | 0.5 | 0.182 | 4.4 |
| 8 | 76.9 | 14.2 | 7.8 | 0.7 | 0.4 | 0.185 | 4.7 |
| 11 | 76.8 | 16.0 | 6.5 | 0.3 | 0.4 | 0.208 | 3.1 |
| 1 | 75.7 | 15.3 | 7.0 | 1.0 | 1.0 | 0.202 | 1.1 |
| 8 | 76.0 | 16.0 | 6.0 | 1.0 | 1.0 | 0.211 | 0.5 |
| 9 | 76.4 | 16.0 | 6.0 | 0.6 | 1.0 | 0.209 | 1.7 |
| 12 | 76.4 | 16.1 | 6.0 | 0.05 | 1.5 | 0.211 | −0.4 |
| 13 | 76.4 | 16.6 | 6.0 | 0.05 | 1.0 | 0.217 | 0.0 |

### [Wrinkle Height]

The wrinkle height refers to a height of streaks and wrinkles formed on a ribbon surface. The nanocrystalline alloy ribbon was interposed between glass plates, and a height of the ribbon surface was measured by a laser microscope VR3200 manufactured by Keyence Corporation. The difference between the maximum value and the minimum value was calculated as the wrinkle height.

The crystalline alloy ribbon was interposed between glass plates, because if the ribbon was very thin and only the ribbon was placed on a measurement stage, parts of the ribbon would be then lifted up due to undulations, etc. and affect the height measurement. The purpose is to minimize such effect.

### [Magnetic Flux Density Br]

A magnetic field of 8000 A/m was applied to a heat treated nanocrystalline alloy ribbon (single sheet sample) using a DC magnetization characteristics test equipment manufactured by Metron Giken Co., Ltd., and the value of magnetic flux density B when the magnetic field was 0 was taken as Br.

### [Iron Loss]

A ring core having an internal diameter of 8.8 mm and an outer diameter of 19.9 mm was punched out from a 15-layer nanocrystalline alloy ribbon and placed in a case. The iron loss was measured using a BH analyzer SY8218 manufactured by Iwatsu Electric Co., Ltd. The measurement conditions employed were primary and secondary windings of 15 turns, a frequency of 20 kHz, and a magnetic flux density of 0.2 T.

As above, according to the present disclosure, a nanocrystalline alloy ribbon having an αFe crystal phase with an average crystal grain size of 50 nm or less and a volume fraction of 40% or more, and a saturation magnetic flux density of 1.36 T or more was obtained. Further, a nanocrystalline alloy ribbon was obtained in which the ratio Br/B₈₀₀₀ of the residual magnetic flux density Br to the magnetic flux density B₈₀₀₀ in a magnetic field of 8000 A/m is 0.20 or more, and the maximum magnetic permeability is 4000 or more.

According to the present disclosure, a nanocrystalline alloy ribbon was obtained in which the ratio (B80_{L}/B80_{W}) of the magnetic flux density B80_{L} when a magnetic field of 80 A/m is applied in the longitudinal direction of the nanocrystalline alloy ribbon to the magnetic flux density B80_{W} when a magnetic field of 80 A/m is applied in the width direction orthogonal to the longitudinal direction is 0.60 to 1.40, and exhibits isotropy properties.

According to the present disclosure, a nanocrystalline alloy ribbon having a saturation magnetostriction of 7 ppm or less was obtained.

According to the present disclosure, a nanocrystalline alloy ribbon having a wrinkle height of 0.15 mm or less and a space factor of 68.0% or more was obtained.

Accordingly, by the present disclosure, a nanocrystalline alloy ribbon having excellent magnetic properties such as high saturation magnetic flux density and high magnetic permeability was obtained. Also, a nanocrystalline alloy ribbon having low magnetostriction, low loss, and isotropy was obtained. In addition, a nanocrystalline alloy ribbon in which wrinkles and streaks are inhibited, and high space factor is achieved was obtained.

### Example 3

In Example 3, an adhesive layer having a thickness of 3 μm was attached to one surface of the nanocrystalline alloy ribbon of Example 1 to prepare a magnetic sheet.

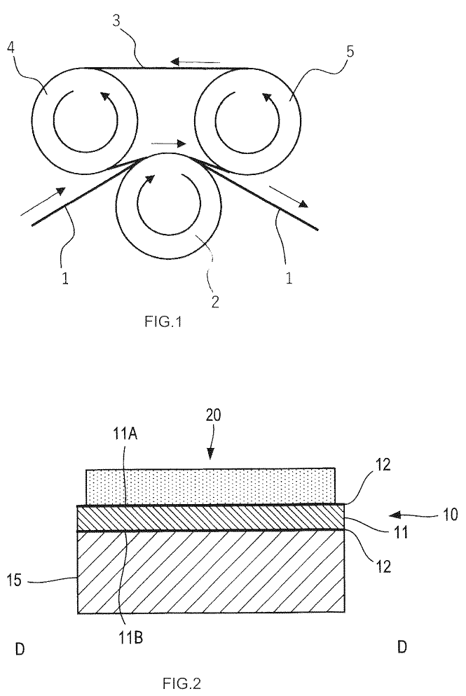

FIG. 2 is a cross-sectional view of the magnetic sheet cut in its width direction for explaining the structure of the magnetic sheet.

As shown in FIG. 2, the magnetic sheet has a laminated structure of one adhesive layer 10, one resin sheet 15, and one nanocrystalline alloy ribbon 20.

The adhesive layer 10 includes a support 11 and adhesives 12. The support 11 is a strip-shaped film member formed in an elongated shape, for example, a film member formed in a rectangular shape. The support 11 is formed using a flexible resin material. As the resin material, polyethyleneterephthalate (PET) can be used.

As the adhesives 12, for example, a pressure sensitive adhesive can be used. For example, known adhesives such as acrylic adhesives, silicone adhesives, urethane adhesives, synthetic rubber, and natural rubber can be used as the adhesive 12. Acrylic adhesives are preferable as the adhesives 12 because they have excellent heat resistance and moisture resistance and can bond a wide range of materials.

The adhesives 12 are each provided in the form of a film or layer on a first surface 11A and a second surface 11B of the support 11. In the adhesive layer 10, the total thickness of the adhesive 12 on the first surface 11A side, the support 11, and the adhesive 12 on the second surface 11B side was 3 μm.

By removing the resin sheet 15, the magnetic sheet can be attached to another member using the adhesive 12 on the second surface 11B side.

In addition, a plurality of the aforementioned magnetic sheets were prepared to produce a magnetic sheet in which a plurality of nanocrystalline alloy ribbons were laminated. The plurality of magnetic sheets were used so that the nanocrystalline alloy ribbons were laminated with the adhesive layer interposed therebetween.

Specifically, firstly, the resin sheet 15 (15B) was peeled off on the side of the adhesive layer 10 of the first magnetic sheet where the nanocrystalline alloy ribbon 20 was not attached. Next, the nanocrystalline alloy ribbon 20 of another magnetic sheet is attached to a portion of the adhesive layer 10 where the adhesive 12 is exposed. By repeating this process, a magnetic sheet with 15 layers of nanocrystalline alloy ribbons was formed.

Using the magnetic sheet with 15 layers of nanocrystalline alloy ribbons, the magnetic sheet was punched out into a ring having an internal diameter of 8.8 mm and an outer diameter of 19.9 mm. Using this ring-shaped magnetic sheet, the iron loss at 128 kHz and 0.2 T and the real part of complex permeability at 128 kHz and 0.03 V were evaluated. The results were shown in Table 6.

Similarly, for Nos. 1 to 11 of Example 2, 15-layer magnetic sheets were also produced, and the iron loss at 128 kHz and 0.2 T and the real part of complex permeability at 128 kHz and 0.03 V were evaluated. The results were shown in Table 6.

According to the present disclosure, a magnetic sheet having an iron loss at 128 kHz and 0.2 T of 2000 kW/m³ or less, and the real part of complex permeability at 128 kHz and 0.03 V of 1500 or more was obtained.

By the present disclosure, a magnetic sheet having excellent magnetic properties was formed.

TABLE 6

| | Iron loss | Real part |
|---|---|---|
| | 128 kHz, 0.2 T | of complex |
| | kW/m3 | permeability |
| Example 1 | 870 | 4109 |
| No. 1 of Example 2 | 887 | 3266 |
| No. 2 of Example 2 | 1200 | 1620 |
| No. 3 of Example 2 | 1442 | 2436 |
| No. 4 of Example 2 | 1066 | 2867 |
| No. 5 of Example 2 | 1244 | 2449 |
| No. 6 of Example 2 | 985 | 2649 |
| No. 7 of Example 2 | 1029 | 3888 |
| No. 8 of Example 2 | 1371 | 2764 |
| No. 9 of Example 2 | 1155 | 2893 |
| No. 11 of Example 2 | 1064 | 4335 |
| No. 12 of Example 2 | 1375 | 3606 |
| No. 13 of Example 2 | 1644 | 2817 |

### Example 4

In Example 4, the adhesive layer 10 having a thickness of 3 μm was attached to one surface of the nanocrystalline alloy ribbon of Example 1, and then cracks 21 were formed in the nanocrystalline alloy ribbon to produce a magnetic sheet.

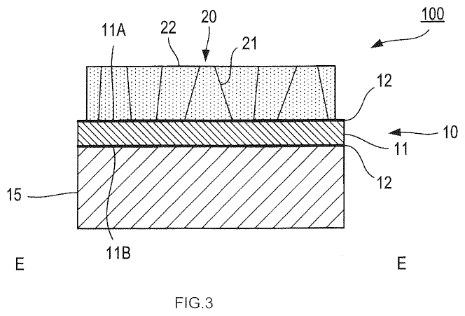

FIG. 3 is a cross-sectional view of the magnetic sheet 100 cut in its width direction for explaining the structure of the magnetic sheet 100.

As shown in FIG. 3, the magnetic sheet 100 has a laminated structure of one adhesive layer 10, one resin sheet 15, and one nanocrystalline alloy ribbon 20. The cracks 21 were formed in the nanocrystalline alloy ribbon 20, and the nanocrystalline alloy ribbon 20 is divided into small pieces 22 by the cracks 21.

A plurality of the aforementioned magnetic sheets were prepared to produce a magnetic sheet in which a plurality of nanocrystalline alloy ribbons were laminated. The plurality of magnetic sheets were used so that the nanocrystalline alloy ribbons 20 were laminated with the adhesive layer 10 interposed therebetween.

Specifically, firstly, the resin sheet 15 was peeled off on the side of the adhesive layer 10 of the first magnetic sheet 100 where the nanocrystalline alloy ribbon 20 was not attached. Next, the nanocrystalline alloy ribbon 20 of another magnetic sheet 100 is attached to a portion of the adhesive layer 10 where the adhesive 12 is exposed. By repeating this process, a magnetic sheet with 15 layers of nanocrystalline alloy ribbons was formed.

Using the magnetic sheet with 15 layers of nanocrystalline alloy ribbons, the magnetic sheet was punched out into a ring having an internal diameter 8.8 mm and an outer diameter of 19.9 mm. Using this ring-shaped magnetic sheet, the iron loss at 128 kHz and 0.2 T and the real part of complex permeability at 128 kHz and 0.03 V were evaluated. The results were shown in Table 7.

Similarly, for No. 4 of Example 2, a 15-layer magnetic sheet was produced, and the iron loss at 128 kHz, and 0.2 T and the real part of complex permeability at 128 kHz and 0.03 V were evaluated. The results were shown in Table 7.

According to the present disclosure, a magnetic sheet having an iron loss at 128 kHz and 0.2 T of 2000 kW/m³ or less and the real part of complex permeability of 400 to 3000 was obtained.

TABLE 7

| | fron loss | Real part |
|---|---|---|
| | 128 kHz, 0.2 T | of complex |
| | W/kg | permeability |
| Example 1 | 1063 | 2002 |
| No. 4 of Example 2 | 1171 | 1568 |

In Examples 3 and 4, the iron loss and the real part of complex permeability were measured by the following method.

### [Iron Loss]

Using a BH analyzer SY8218 manufactured by Iwatsu Electric Co., Ltd., a ring core having an internal diameter of 8.8 mm and an outer diameter of 19.9 mm was punched out from the 15-layer magnetic sheet and placed in a case, and the iron loss was measured. The measurement conditions employed were primary and secondary windings with 15 turns, 128 kHz, and a magnetic flux density of 0.2 T for iron loss.

### [Complex Magnetic Permeability]

Using a BH analyzer SY8218 manufactured by Iwatsu Electric Co., Ltd., a ring core having an internal diameter of 8.8 mm and an outer diameter of 19.9 mm was punched out from the IS-layer magnetic sheet and placed in a case, and the real part of complex permeability was measured. The measurement conditions employed were primary and secondary windings with 15 turns, a frequency of 128 kHz, and a voltage of 0.03 V.

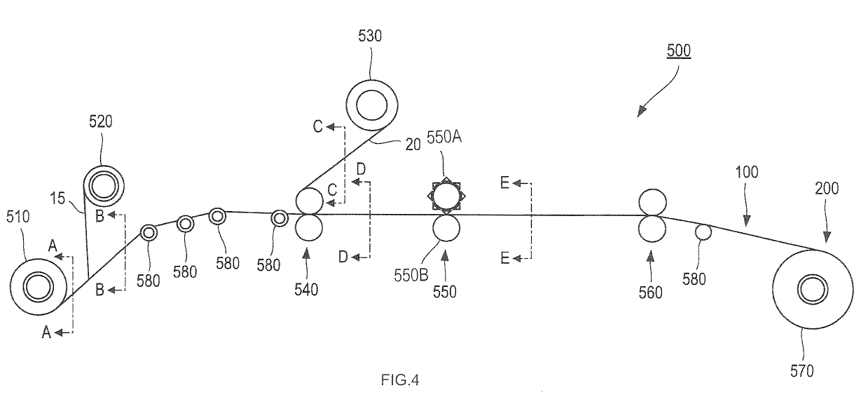

FIG. 4 is a schematic diagram explaining a method for manufacturing a magnetic sheet 100 having one layer of nanocrystalline alloy ribbon of the present disclosure. FIG. 4 shows a method for continuously attaching the adhesive layer 10 to the nanocrystalline alloy ribbon 20.

The magnetic sheet 100 is manufactured using a manufacturing apparatus 500 shown in FIG. 4. The manufacturing apparatus 500 comprises, from an upstream side to a downstream side in the manufacturing process, a first unwinding roll 510, a first winding roll 520, a second unwinding roll 530, a plurality of attaching rollers 540, a crack section 550, a flattening roller 560, and a third winding roll 570. The manufacturing apparatus 500 may further comprise a plurality of guide rollers 580. The guide roller 580 may be arranged as required at a position not shown.

FIG. 5 is a cross-sectional view for explaining a configuration of a laminate supplied from the first unwinding roll 510.

As shown in FIG. 5, a laminate in which the resin sheets 15A, 15B are laminated on the first surface 11A and the second surface 11B of the adhesive layer 10 is wound around the first unwinding roll 510.

The resin sheet 15A disposed on the first surface 11A is a protective sheet. The resin sheet 15B disposed on the second surface 11B is also referred to as a liner. The resin sheet 15A is thinner than the resin sheet 15B disposed on the second surface 11B.

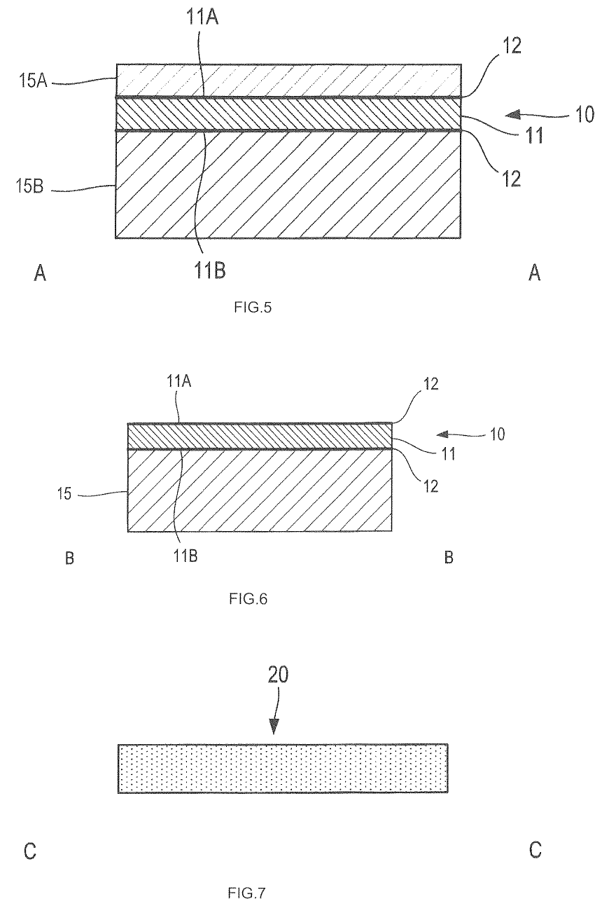

FIG. 6 is a cross-sectional view for explaining a configuration of the laminate supplied from the first unwinding roll 510 and from which the resin sheet 15A has been peeled off.

As shown in FIG. 6, the resin sheet 15A is peeled off from the laminate unwound from the first unwinding roll 510. As shown in FIG. 4, the peeled resin sheet 15A is wound around the first winding roll 520.

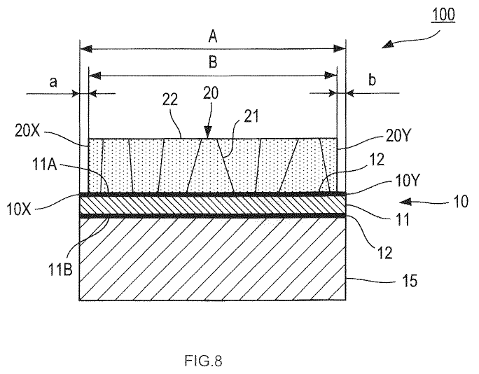

FIG. 7 is a cross-sectional view for explaining a configuration of the nanocrystalline alloy ribbon 20 supplied from the second unwinding roll 530.

The laminate from which the resin sheet 15A has been peeled off is guided to the attaching rollers 540 by the plurality of guide rollers 580. The nanocrystalline alloy ribbon 20 unwound from the second unwinding roll 530 is further guided to the attaching rollers 540. As shown in FIG. 7, there is no crack 21 formed in the nanocrystalline alloy ribbon 20 guided to the attaching rollers 540.

FIG. 2 is a cross-sectional view for explaining a state in which the nanocrystalline alloy ribbon 20 has been bonded to the adhesive layer 10 by the attaching rollers 540.

As shown in FIG. 4, the attaching rollers 540 include two cylindrical rollers disposed opposite to each other. Each of the two rollers has a smooth peripheral surface without protrusions. The two rollers press and bond the nanocrystalline alloy ribbon 20 to the laminate from which the resin sheet 15A has been peeled off.

Specifically, the laminate and the nanocrystalline alloy ribbon 20 are guided between the two rollers disposed opposite to each other, and the nanocrystalline alloy ribbon 20 is pressed and bonded to the first surface 11A of the adhesive layer 10 using the two rollers, as shown in FIG. 2. The laminate to which the nanocrystalline alloy ribbon 20 is bonded is guided from the attaching rollers 540 to the crack section 550, as shown in FIG. 4.

In case that the cracks 21 are not to be formed, the laminate may be wounded around the third winding roll 570 without being guided to the crack section 550, or may be cut to a desired length.

FIG. 3 is a cross-sectional view for explaining a state in which the cracks 21 have been formed in the nanocrystalline alloy ribbon 20 by the crack section 550.

The crack section 550 forms the cracks 21 in the nanocrystalline alloy ribbon 20 bonded to the adhesive layer 10. Specifically, the crack section 550 comprises two rollers disposed opposite to each other. Specifically, the crack section 550 comprises a crack roller 550A and a support roller 550B.

The manufacturing apparatus 500 guides the laminate to which the nanocrystalline alloy ribbon 20 is bonded between these two rollers. The crack roller 550A is a cylindrical roller in which protrusions are arranged on the peripheral surface. The support roller 550B is a cylindrical roller in which no protrusion is provided on the peripheral surface. The manufacturing apparatus 500 forms cracks 21 by pressing the protrusions of the crack roller 550A against the nanocrystalline alloy ribbon 20, as shown in FIG. 3.

The support roller 550B is disposed on the side of the laminate from which the resin sheet 15 has been peeled off. The nanocrystalline alloy ribbon 20 with in which the cracks 21 are formed includes a plurality of small pieces 22. The plurality of small pieces 22 are bonded to the adhesive layer 10.

A configuration of the crack roller 550A will be described. In the crack roller 550A, a plurality of convex members are arranged on the peripheral surface as the aforementioned cove members. The shape of a tip end of each of the convex members of the crack roller 550A may be flat, conical, inverted conical with a recessed center, or cylindrical. The plurality of convex members may be arranged regularly or irregularly.

The laminate guided from the crack section 550 to the flattening roller 560 is subject to flattening treatment by the flattening roller 560. The flattening roller 560 is also referred to as a shaping roller.

Specifically, the laminate is guided between the two rollers disposed opposite to each other in the flattening roller 560, and is sandwiched and pressed by the two rollers. As a result, the surface of the nanocrystalline alloy-ribbon 20 in which the cracks 21 are formed is flattened.

The laminate subjected to the flattening treatment becomes the magnetic sheet 100. The magnetic sheet 100 is guided to the third winding roll 570 via the guide roller 580. The magnetic sheet 100 is wound around the third winding roll 570. The magnetic sheet 100 that is wound around the third winding roll 570 and has a ring-like or spiral shape is a wound magnetic sheet 200.

The magnetic sheet 100 may be wound up, or may be cut to a specified length without being wound up.

It is preferable that the width B of the nanocrystalline alloy ribbon 20 and the width A of the adhesive layer 10 have a shape that satisfies a relationship of the following formula (see FIG. 8).

$$0.2 mm \leq ( width A - width B ) \leq 3 mm$$

The width A is a dimension related to the adhesive layer 10, and more preferably a dimension related to a region provided with the adhesive 12 to which the nanocrystalline alloy ribbon 20 is bonded in the adhesive layer 10. The width B is a dimension related to the nanocrystalline alloy ribbon 20. When the adhesive 12 is provided on the entire surface of the support 11 of the adhesive layer 10, the width A is a dimension related to the adhesive layer 10 or the support 11.

A lower limit of (width A−width B) is preferably 0.5 mm, and more preferably 1.0 mm. An upper limit of (width A−width B) is preferably 2.5 mm, and more preferably 2.0 mm.

The nanocrystalline alloy ribbon 20 may be arranged such that its center coincided with the center of the adhesive layer 10 in the width direction, or may be arranged such that its center is away from the adhesive layer 10. In this case, the arrangement is made to satisfy a relationship 0 mm<gap a, and 0 mm<gap b (see FIG. 8).

The gap a and the gap b are distances from the ends of the adhesive layer 10 to the ends of the nanocrystalline alloy ribbon 20. Specifically, the gap a is a distance from a first adhesive layer end 10X of the adhesive layer 10 to a first ribbon end 20X of the nanocrystalline alloy ribbon 20. The gap b is a distance from a second adhesive layer end 10Y of the adhesive layer 10 to a second ribbon end 20Y of the nanocrystalline alloy ribbon 20.

The first ribbon end 20X is an end of the nanocrystalline alloy ribbon 20 on the same side as the first adhesive layer end 10X. The second adhesive layer end 10Y is an end of the adhesive layer 10 opposite to the first adhesive layer end 10X. The second ribbon end 20Y is an end of the nanocrystalline alloy ribbon 20 on the same side as the second adhesive layer end 10Y.

The width A, the width B, the gap a, and the gap b are dimensions in a direction intersecting, or more preferably orthogonal to, the longitudinal direction of the magnetic sheet 100. The longitudinal direction of the magnetic sheet 100 and the longitudinal direction of the adhesive layer 10 are the same direction. The longitudinal direction of the magnetic sheet 100 and the longitudinal direction of the nanocrystalline alloy ribbon 20 are also the same direction.

In the magnetic sheet 100, the width A of the region of the adhesive layer 10 where the adhesive 12 is provided is set to be larger than the width B of the nanocrystalline alloy ribbon 20. With this configuration, even if the adhesive layer 10 or the nanocrystalline alloy ribbon 20 meanders when attaching the nanocrystalline alloy ribbon 20 to the adhesive layer 10, the adhesive 12 of the adhesive layer 10 can be easily disposed on the entire surface of the nanocrystalline alloy ribbon 20. Further, by disposing the adhesive layer 10 on the entire surface of the nanocrystalline alloy ribbon 20, it is possible, after the cracks 21 are formed in the nanocrystalline alloy ribbon 20 and the small pieces 22 are formed, to inhibit the small pieces 22 from falling off.

In the magnetic sheet 100, a value obtained by subtracting the width B from the width A is set to be 0.2 mm or more. With this configuration, when the nanocrystalline alloy ribbon 20 is attached to the adhesive layer 10, it is easy to inhibit generation of a portion of the nanocrystalline alloy ribbon 20 where the adhesive 12 is not disposed.

In the magnetic sheet 100, a value obtained by subtracting the width B from the width A is set to be 3 mm or less. With this configuration, increase of the portion of the magnetic sheet 100 where the nanocrystalline alloy ribbon 20 is not disposed can be easily inhibited. Further, when the magnetic sheets 100 are aligned in parallel, it is easy to inhibit an interval (magnetic gap) between the nanocrystalline alloy ribbons from increasing.

The magnetic sheet 100 is set to satisfy the relationship 0 mm<gap a and 0 mm<gap b. With this configuration, when the nanocrystalline alloy ribbon 20 is attached to the adhesive layer 10, it is easy to inhibit the nanocrystalline alloy ribbon 20 from protruding from the region where the adhesive 12 is provided. Thus, it is easy to inhibit generation of a portion of the nanocrystalline alloy ribbon 20 where the adhesive 12 is not disposed.

According to the present disclosure, a nanocrystalline alloy ribbon with high saturation magnetic flux density and high magnetic permeability was obtained. In addition, according to the present disclosure, a nanocrystalline alloy ribbon with low magnetostriction, low loss, and isotropy was obtained. Further, according to the present disclosure, a nanocrystalline alloy ribbon with reduced wrinkles and streaks and high space factor was obtained.

According to the present disclosure, a magnetic sheet using a nanocrystalline alloy ribbon having excellent magnetic properties was obtained.

1. A nanocrystalline alloy ribbon represented by a composition formula: (Fe₁₋ₓAₓ)ₐSi_{b}B_{c}Cu_{d}Mₑ, wherein A is at least one type of Ni and Co, M is at least one type of element selected from a group consisting of Nb, Mo, V, Zr, Hf and W, and in at %, 75.0≤a≤81.0, 9.0≤b≤18.0, 5.0≤c≤10.0, 0.02≤d≤1.2, 0.1≤e≤1.5, and 0≤x≤0.1 are satisfied, an αFe crystal phase having an average crystal grain size of 50 nm or less accounts for 40% or more by volume fraction, a saturation magnetic flux density is 1.36 T or more, a ratio Br/B₈₀₀₀ of a residual magnetic flux density Br to a magnetic flux density B₈₀₀₀ at a magnetic field of 8000 A/m is 0.20 or more, and a maximum magnetic permeability is 4000 or more.

2. The nanocrystalline alloy ribbon according to claim 1, wherein a ratio (B80_{L}/B80_{W}) of a magnetic flux density B80_{L} when a magnetic field 80 A/m is applied in a longitudinal direction of the nanocrystalline alloy ribbon to a magnetic flux density B80_{W} when a magnetic field 80 A/m is applied in a width direction orthogonal to the longitudinal direction is 0.60 to 1.40, and both B80_{L} and B80_{W} are 0.4 T or more.

3. The nanocrystalline alloy ribbon according to claim 1, wherein the nanocrystalline alloy ribbon has a saturation magnetostriction of 7 ppm or less.

4. The nanocrystalline alloy ribbon according to claim 1, wherein the nanocrystalline alloy ribbon has a thickness of 20 μm or less, and a width of 5 mm or more.

5. The nanocrystalline alloy ribbon according to claim 1, wherein the nanocrystalline alloy ribbon has a wrinkle height of 0.15 mm or less, and a space factor of 68.0% or more.

6. A magnetic sheet comprising:
a nanocrystalline alloy ribbon represented by a composition formula: (Fe₁₋ₓAₓ)ₐSi_{b}B_{c}Cu_{d}Mₑ, wherein A is at least one type of Ni and Co, M is at least one type of element selected from a group consisting of Nb, Mo, V, Zr, Hf and W, and in at %, 75.0≤a≤81.0, 9.0≤b≤18.0, 5.0≤c≤10.0, 0.02≤d≤1.2, 0.1≤e≤1.5, and 0≤x≤0.1 are satisfied, an αFe crystal phase having an average crystal grain size of 50 nm or less accounts for 40% or more by volume fraction, a saturation magnetic flux density is 1.36 T or more, a ratio Br/B₈₀₀₀ of a residual magnetic flux density Br to a magnetic flux density B₈₀₀₀ at a magnetic field of 8000 A/m is 0.20 or more, and a maximum magnetic permeability is 4000 or more; and
an adhesive layer with a support formed in a ribbon shape, and an adhesive provided on at least one of a first surface and a second surface of the support, wherein
the nanocrystalline alloy ribbon is bonded to the adhesive of the adhesive layer, and
the adhesive layer has a thickness of 1 to 10 μm.

7. A magnetic sheet comprising:
a nanocrystalline alloy ribbon represented by a composition formula: (Fe₁₋ₓAₓ)ₐSi_{b}B_{c}Cu_{d}Mₑ, wherein A is at least one type of Ni and Co, M is at least one type of element selected from a group consisting of Nb, Mo, V, Zr, Hf and W, and in at %, 75.0≤a≤81.0, 9.0≤b≤18.0, 5.0≤c≤10.0, 0.02≤d≤1.2, 0.1≤e≤1.5, and 0≤x≤0.1 are satisfied, an αFe crystal phase having an average crystal grain size of 50 nm or less accounts for 40% or more by volume fraction, a saturation magnetic flux density is −1.36 T or more, a ratio Br/B₈₀₀₀ of a residual magnetic flux density Br to a magnetic flux density B₈₀₀₀ at a magnetic field of 8000 A/m is 0.20 or more, and a maximum magnetic permeability is 4000 or more; and
an adhesive layer with a support formed in a ribbon shape and adhesives each provided on a first surface and a second surface of the support, wherein
the adhesive layer has a thickness of 1 to 10 μm, and
a plurality of the nanocrystalline alloy ribbons are formed in multiple layers with the adhesive layer in between.

8. The magnetic sheet according to claim 6, wherein an iron loss at 128 kHz and 0.2 T is 2000 kW/m³ or less, and a real part of complex permeability at 128 kHz and 0.03 V is 1500 or more.

9. The magnetic sheet according to claim 6, wherein cracks are formed in the nanocrystalline alloy ribbon.

10. The magnetic sheet according to claim 9, wherein an iron loss at 128 kHz and 0.2 T is 2000 kW/m³ or less, and a real part of complex permeability at 128 kHz and 0.03 V is 400 to 3000.

11. The magnetic sheet according to claim 7, wherein an iron loss at 128 kHz and 0.2 T is 2000 kW/m³ or less, and a real part of complex permeability at 128 kHz and 0.03 V is 1500 or more.

12. The magnetic sheet according to claim 7, wherein cracks are formed in the nanocrystalline alloy ribbon.

13. The magnetic sheet according to claim 12, wherein an iron loss at 128 kHz and 0.2 T is 2000 kW/m³ or less, and a real part of complex permeability at 128 kHz and 0.03 V is 400 to 3000.
